(19) United States
(12) Patent Application Publication
(10) Pub. No.: US 2023/0407069 A1
(43) Pub. Date: Dec. 21, 2023

(54) LOW-SMOKE SELF-EXTINGUISHING ELECTRICAL CABLE AND FLAME-RETARDANT COMPOSITION USED THEREIN

(71) Applicant: Basell Polyolefine GmbH, Wesseling (DE)

(72) Inventors: Christof Justus, Schloß Holte-Stukenbrock (DE); Alexander Rodionov, Frankfurt am Main (DE); Alexander Kulichenko, Moscow (RU); Cristinel Degeratu, Delft (NL)

(73) Assignee: Basell Polyolefine GmbH, Wesseling (DE)

(21) Appl. No.: 18/253,972

(22) PCT Filed: Nov. 16, 2021
(86) PCT No.: PCT/EP2021/081809

§ 371 Date: May 23, 2023

(30) Foreign Application Priority Data
Nov. 26, 2020 (EP) 20210105.1

(51) Int. Cl. C08L 23/08; H01B 3/44; H01B 7/295; C08L 51/00; C08K 3/22; C08L 33/08

(52) U.S. Cl. CPC C08L 23/0869; H01B 3/441; H01B 7/295; H01B 3/447; C08K 2003/2224; C08L 51/003; C08K 3/22; C08L 33/08; C08L 2203/202; C08L 23/0815

(57) ABSTRACT

A thermoplastic composition made from or containing (i) a polyolefin portion made from or containing (a) an ethylene/alkyl acrylate, (b) a polyolefin elastomer selected from copolymers of ethylene with a C₃-C₁₅ alpha-olefin, and optionally with a diene, having a density of from 0.860 to g/cm³, (c) an ethylene polymer grafted with carboxyl groups or organic silane groups, and optionally (d) a copolymer of ethylene with a C₄-C₁₀ alpha-olefin, having a density of from 0.910 to g/cm³, and (ii) a mineral portion made from or containing (e) magnesium hydroxide, wherein the components (a)-(e) being present in amount such that the weight ratio (e)/polyolefin portion ranges from 0.8:1 to 1.75:1, the weight ratio (a)/(b) ranges from 0.75:1 to 1.25:1, and the weight ratio (a)/(e) ranges from 0.15:1 to 0.4:1; and wherein the thermoplastic composition has a melt flow rate of at least 2 g/10 min.

### FIELD OF THE INVENTION

In general, the present disclosure relates to the field of chemistry. More specifically, the present disclosure relates to polymer chemistry. In particular, the present disclosure relates to coated electrical cables and to the flame-retardant compositions used therein.

### BACKGROUND OF THE INVENTION

In some instances and because of the risk of fire, electrical cables are coated with self-extinguishing and flame-retardant polymer compositions. In some instances, the fire-resistant properties are achieved from an additive.

In some instances, polyolefin-based compositions made from or containing polyethylene or ethylene/vinyl acetate copolymers, an organic halide, and antimony trioxide are used for this purpose. In some instances, halogenated flame-retardant additives have drawbacks arising when the additives partially decompose during processing of the polymer. In those instances, the additives generate halogenated gases which may be toxic to workers or corrode metal parts of the polymer-processing equipment. Similarly, when the halogenated flame-retardant additives are placed directly in a flame, the additives may generate smoke containing toxic gases. In some instances, polymer compositions made from or containing polyvinylchloride (PVC) and antimony trioxide have similar drawbacks.

In some instances, self-extinguishing flame retardant cables are made from or containing halogen-free compositions. In some instances, the flame-retardant agents are inorganic oxides. In some instance, the inorganic oxides are in the hydrate or hydroxide form, including magnesium hydroxide and aluminum trihydrate.

### SUMMARY OF THE INVENTION

In a general embodiment, the present disclosure provides a thermoplastic composition for electrical cable coating made from or containing:
(i) a polyolefin portion made from or containing
   (a) an ethylene copolymer,
   (b) a polyolefin elastomer (POE),
   (c) a polymeric coupling agent, and optionally
   (d) a copolymer of ethylene with a C₄-C₁₀ alpha-olefin, and
(ii) a mineral portion made from or containing
   (e) magnesium hydroxide,
wherein the components (a)-(e) being present in amounts such that the weight ratio of (e)/polyolefin portion ranges from 0.8:1 to 1.75:1, the weight ratio of (a)/(b) ranges from to 1.25:1, and the weight ratio of (a)/(e) ranges from 0.15:1 to 0.4:1; and wherein the thermoplastic composition having a melt flow rate (MFR) at 190° C. with a load of 21.6 kg, according to ISO 1133-2:2011, of at least 2 g/10 min.

In some embodiments, the present disclosure provides an electrical cable coated with a layer made from or containing the thermoplastic composition.

### DETAILED DESCRIPTION OF THE INVENTION

In some embodiments, the present disclosure provides a thermoplastic composition for electrical cable coating made from or containing:
(i) a polyolefin portion made from or containing
   (a) an ethylene copolymer being an ethylene/alkyl acrylate,
   (b) a polyolefin elastomer (POE) selected from copolymers of ethylene with a C₃-C₁₅ alpha-olefin, and optionally with a diene, having a density (ASTM D505) of from to 0.904 g/cm³;
   (c) a polymeric coupling agent selected from ethylene polymers grafted with carboxyl groups or organic silane groups, and optionally
   (d) a copolymer of ethylene with a C₄-C₁₀ alpha-olefin, having a density of from 0.910 to 0.924 g/cm³, and
(ii) a mineral portion made from or containing
   (e) magnesium hydroxide,
wherein the components (a)-(e) being present in amounts such that the weight ratio of (e)/polyolefin portion ranges from 0.8:1 to 1.75:1, the weight ratio of (a)/(b) ranges from to 1.25:1, and the weight ratio of (a)/(e) ranges from 0.15:1 to 0.4:1; and
wherein the thermoplastic composition having a melt flow rate (MFR) at 190° C. with a load of 21.6 kg, according to ISO 1133-2:2011, of at least 2 g/10 min, alternatively at least 2.5 g/10 min.

In some embodiments, the features of the copolymers (a)-(d) are not inextricably linked. As such, a selection of a feature may not involve the same selection of the remaining features.

As used herein, the term “copolymer” refers to both polymers with two different recurring units and polymers with more than two different recurring units, such as terpolymers, in the chain.

In some embodiments, the ethylene copolymer (a) is selected from the group consisting of ethylene/butyl acrylate (EBA), ethylene/ethyl acrylate (EEA), and ethylene/methyl acrylate (EMA). In some embodiments, the content of alkyl acrylate in the ethylene copolymer ranges from 5 to 25 wt %, alternatively from 10 to 20 wt %, based upon the total weight of the ethylene copolymer.

In some embodiments, the MFR of the ethylene copolymer (a) ranges from 0.5 to 25 g/10 min, alternatively from 1 to 20 g/10 min. In some embodiments, the density of the ethylene copolymer (a) ranges from 0.920 to 0.935 g/cm³.

In some embodiments, the ethylene copolymer (a) is prepared produced by high-pressure polymerization where ethylene and comonomer are polymerized in the presence of oxygen or a peroxide as initiator.

In some embodiments, the polyolefin elastomer (POE) (b) is a copolymer of ethylene with an C₃-C₁₅ alpha-olefin selected from the group consisting of propylene, 1-butene, 1-pentene, 4-methyl-1-pentene, 1-hexene, and 1-octene. In some embodiments, the C₃-C₁₅ alpha-olefin selected from the group consisting of 1-butene and 1-octene.

In some embodiments, the polyolefin elastomer (POE) (b) is a copolymer of ethylene with an C₃-C₁₅ alpha-olefin and a diene. In some embodiments, the diene comonomer has from 4 to 20 carbon atoms. In some embodiments, the diene comonomer is selected from linear, conjugated or non-conjugated diolefins and monocyclic or polycyclic dienes. In some embodiments, the diolefins are selected from the group consisting of 1,3-butadiene, 1,4-hexadiene, and 1,6-octadiene. In some embodiments, the monocyclic or polycyclic dienes are selected from the group consisting of 1,4-cyclohexadiene, 5-ethylidene-2-norbornene, and 5-methylene-2-norbornene.

In some embodiments, the POE contains a C₄-C₁₂ alpha-olefin. In some embodiments, the C₄-C₁₂ alpha-olefin is 1-octene. In some embodiments, the amount of alpha olefin ranges from 3-25% by mole, alternatively from 5-10% by mole.

In some embodiments, the density of the POE ranges from 0.870 and 0.90 g/cm³. In some embodiments, the POE has a MFR at 190° C. with a load of 2.16 kg, according to ISO 1133-2:2011, ranging from 0.1 and 30 g/10 min, alternatively between 0.5 and 5 g/10 min.

As used herein, the term “Molecular Weight Distribution (MWD) index” refers to the ratio between the weight-average molecular weight Mw and the number-average molecular weight Mn. In some embodiments, the POE (b) has a Molecular Weight Distribution (MWD) index of less than 5, alternatively between 1.5 and 3.5. In some embodiments, the MWD index is determined by Gel Permeation Chromatography (GPC).

In some embodiments, the POE (b) is produced by copolymerization of ethylene with an alpha-olefin, and optionally with a diene, in the presence of a single-site catalyst. In some embodiments, the copolymerization process is as described in Patent Cooperation Treaty Publication No WO 93/19107, European Patent Application No. EP-A-632,065, U.S. Pat. Nos. 5,246,783, or 5,272,236. In some embodiments, the single-site catalyst is a metallocene catalyst.

In some embodiments, the catalysts are “Constrained Geometry Catalysts” as described in European Patent Nos. EP-416,815 and EP-418,044.

In some embodiments, the polymeric coupling agent (c) is a maleic anhydride grafted polyethylene (MAHg-PE). In some embodiments, the maleic anhydride grafted polyethylenes (MAHg-PE) are obtained by modification of ethylenic resins by a chemical compound containing maleic acid or maleic anhydride. In some embodiments, the ethylenic resins, in unmodified form, have a melt index in the range of about 0.1 to about 50 g/10 min and a density in the range of about 0.860 to 0.950 g/cm³. In some embodiment, the ethylenic resins are polyethylene resins. In some embodiment, the ethylenic resin is an ethylene/alpha-olefin copolymer produced using Ziegler-Natta catalyst systems, Phillips catalyst systems, or metallocene-based transition metal catalyst systems. In some embodiments, the copolymer is a very low density polyethylene (VLDPE), a linear low density polyethylene (LLDPE), a medium density polyethylene (MDPE) having a density in the range of to 0.940 g/cm³, or a high density polyethylene (HDPE) having a density greater than 0.940 g/cm³. In some embodiments, the ethylenic resins are EVAs, EEAs, high pressure low density polyethylenes (HP-LDPE), or ethylene/alpha-olefin copolymers produced by employing single site metallocene catalysts. HP-LDPE is a homopolymer. In some embodiments, these ethylenic resins are referred to generically as polyethylenes.

In some embodiments, the content of grafted organo-functional group is in the range of about 0.05 to about 10 weight percent based on the weight of the resin. In some embodiments, the modification is achieved by solution, suspension, or melting methods. In some embodiments, the solution method is effected by mixing an organo-functional group containing chemical, an ethylenic resin, a non-polar organic solvent, and a free radical initiator, and then heating the mixture to about 100 to about 160° C., thereby performing the modification reaction. In some embodiments, the free radical initiator is an organic peroxide.

In some embodiments, the copolymer of ethylene with a C₄-C₁₀ alpha-olefin (d) has a density of from 0.912 to 0.922 g/cm³. In some embodiments, the copolymer (d) is prepared with a low-pressure processes in the presence of a Ziegler-Natta catalyst, a chromium-based catalyst, or a metallocene-based catalyst. In some embodiments, the copolymer (d) is prepared with a low-pressure processes in the presence of a metallocene based catalyst. In some embodiments, the alpha-olefin is 1-butene, 1-hexene, or 1-octene. In some embodiments, the alpha-olefin is present in the copolymer in an amount of from 1 to 12% by moles, alternatively 3-10% by moles. In some embodiments, the copolymer (d) has a melt flow rate (MFR) at 190° C. with a load of 2.16 kg, according to ISO 1133-2:2011, ranging from 0.5 and 20 g/10 min, alternatively from 1.0 and 10 g/10 min.

In some embodiments, the magnesium hydroxide (e) is selected from the group consisting of natural magnesium hydroxide, synthetic magnesium hydroxide, and surface-treated magnesium hydroxide.

As used herein, the term “natural magnesium hydroxide” refers to magnesium hydroxide obtained by grinding minerals based on magnesium hydroxide, such as brucite and the like.

Brucite was formed in the deposits of magnesium containing minerals. In some embodiments, brucite is found in combination with other minerals such as magnesite, dolomite, serpentine, and calcite.

In some embodiments, the grinding takes place under wet or dry conditions. In some embodiments, the grinding takes place in the presence of grinding coadjuvants. In some embodiments, the coadjuvants are polyglycols. In some embodiments, the specific surface area of the ground product is between 5 and 20 m²/g, alternatively between 6 and 15 m²/g. In some embodiments, the magnesium hydroxide is classified to obtain an average particle diameter between 1 and 15 um, alternatively between 1.5 and 5 um. In some embodiments, the magnesium hydroxide is classified to obtain a particle size distribution such that not more than 10% of the total number of particles have a diameter lower than 1.5 um, and not more than 10% of the total number of particles have a diameter greater than 20 um. In some embodiments, the classifying is achieved by sieving the magnesium hydroxide.

In some embodiments, the natural magnesium hydroxide contains three main impurities selected from the group consisting of CaO, SiO2, and Fe2O3 based compounds derived from magnesium hydroxide's mineral origin. In some embodiments, the degree of purity is between 80 and 98% by weight.

In some embodiments, a surface-treated magnesium hydroxide is the product obtained by treating natural magnesium hydroxide surface with agents, thereby increasing the compatibility of the magnesium hydroxide with the polymer matrix. In some embodiments, the agents are saturated or unsaturated fatty acids containing from 8 to 24 carbon atoms, or metal salts thereof. In some embodiments, the agents are selected from the group consisting of oleic acid, palmitic acid, stearic acid, isostearic acid, lauric acid, and magnesium or zinc stearate or oleate. In some embodiments, the agents are organic silanes or titanates. In some embodiments, the agents are selected from the group consisting of vinyltriethoxysilane, vinyltriacetylsilane, tetraisopropyltitanate, and tetra-n-butyltitanate. In some embodiments, the magnesium hydroxide is surface treated with organic silanes.

In some embodiments, the synthetic magnesium hydroxide is obtained by precipitation techniques and characterized by the presence of flattened hexagonal crystallites that are uniform both in size and morphology.

In some embodiments, the components (a) to (e) of the thermoplastic composition are present in amount such that the weight ratio (e)/polyolefin portion ranges from 1:1 to 1.65:1, the weight ratio (a)/(b) ranges from 0.85:1 to 1.15:1, and the weight ratio (a)/(e) ranges from 0.25:1 to 0.35:1.

In some embodiments, the thermoplastic composition has the following composition expressed as parts per hundred resin (phr):
Ethylene copolymer (a) from 25 to 60; alternatively 30 to 50;
Polyolefin elastomer (b) from 25 to 60; alternatively 30 to 50;
Polymeric coupling agent (c) from 5 to 20; alternatively 7 to 15;
Ethylene copolymer (d) from 5 to 20; alternatively 7 to 15; and
Magnesium hydroxide (e) from 120 to 180; alternatively 130 to 170.

In some embodiments, the thermoplastic composition has a melt flow rate (MFR) at 190° C. with a load of 21.6 kg, according to ISO 1133-2:2011, of at least 2 g/10 min, alternatively at least 2.5 g/10 min, alternatively in the range from 4 to 8 g/10′.

In some embodiments, the thermoplastic composition is further made from or containing an additive package in amount from 1 to 10 phr.

In some embodiments, the additive package is made from or containing additives selected from the group consisting of antioxidants, processing coadjuvants, lubricants, pigments, and fillers.

In some embodiments, the antioxidants are selected from the group consisting of polymerized trimethyldihydroquinoline, 4,4′-thiobis (3-methyl-6-tert-butyl) phenol, pentaerythritol tetrakis 3-(3,5-di-tert-butyl-4-hydroxyphenyl) propionate, 2,2′-thio-diethylene-bis-3-(3,5-di-tert-butyl-4-hydroxy-phenyl) propionate, and mixtures thereof.

In some embodiments, the fillers are selected from the group consisting of calcium carbonate, glass particles, glass fibers, calcined kaolin, talc, and mixtures thereof. In some embodiments, processing co-adjuvants are calcium stearate or zinc stearate.

In some embodiments, the coating of the cable made from or containing the thermoplastic composition is not cross-linked. In some embodiments, the thermoplastic composition and the cable coating made therefrom are fully recyclable.

In some embodiments, the components of the thermoplastic composition are mixed together using an internal mixer of the type with tangential rotors (Banbury) or with interpenetrating rotors, alternatively in continuous mixers. In some embodiments, the continuous mixers are selected from the group consisting of Ko-Kneader (Buss), Farrel continuous mixer, and co-rotating or counter-rotating twin-screw mixers.

In some embodiments, the present disclosure provides an electrical cable coated with the thermoplastic compositions. In some embodiments, the thermoplastic compositions directly coat the conductor of the cable or coat a previously coated insulating or bedding layer.

In some embodiments, the cable coating is carried out by extrusion. In some embodiments, two layers are present, and the extrusion is carried out in two separate stages, wherein the inner layer is extruded onto the conductor in a first run and the outer layer is extruded onto this inner or bedding layer in a second run. In some embodiments, two layers are present, and the extrusion is carried out by co-extrusion using a single extrusion head.

The following examples are given to illustrate, but not limit the present disclosure.

### EXAMPLES

### Characterizations

Melt Flow Rate (MFR)

Measured according to ISO 1133 at 190° C. with a load of 21.6 kg, unless otherwise specified.

Samples for the Mechanical Tests

The samples were prepared on a roll mill with a gap of 1.2-1.3 mm between the rolls. The samples were homogenized at a temperature in the range 130-140° C. and a mixing time of around 10 min.

Elongation at break: measured according to ISO 527 1-2

Tensile Stress at break: measured according to ISO 527 1-2

Cone Calorimeter Test

Carried out according to ISO 5660-1 2015.

Measurement of Limited Oxygen Index (LOI).

The LOI was measured according to ISO 4589-2 on specimen with a thickness of 3 mm, a width of 6.5 mm, and a length of 100 mm. The specimens were obtained by compression molding and cutting.

Materials

Component (a):
(a1) Lucalen LC A2700H was an EBA copolymer containing 15% of BA with a MFR of 1.4 g/10 min and a density of 0.922, which was commercially available from LyondellBasell.
(a2) Lucalen LC A2700M was an EBA copolymer containing 17% of BA with a MFR of 7.2 g/10 min and a density of 0.924, which was commercially available from LyondellBasell.
(a3) Elvax 265 was an EVA copolymer containing 28% of VA with a MFR of 3.0 g/10 min and a density of 0.951, which was commercially available from The Dow Chemical Company.

Component (b)

Lucene LC180 was an ethylene/octene-1 copolymer obtained by polymerization in the presence of a metallocene catalysts having a density (ASTM D1505) of 0.885 g/cm³ and a MFR of 1.2 g/10 min, which was commercially available from LG Chem.

Component (c)

Compoline CO/UL05 was a maleic anhydride grafted ethylene copolymer, which was commercially available from Auserpolimeri.

Component (d)

Exceed 3518CB was an ethylene/hexene-1 copolymer obtained by polymerization in the presence of a metallocene catalysts having a density of 0.918 g/cm³ and a MFR of 3.5 g/10 min, which was commercially available from ExxonMobil Chemical.

Component (e)
(e1) Ecopiren 3.5 was a natural Mg hydroxide obtained by brucite grinding, which was distributed by Europiren B.V and produced by Russian Mining Chemical Company LLC. Ecopiren 3.5 had a D50 particle size of 3-4 μm, a surface area of 11-13 m²/g, and a minimum Mg(OH)₂ content of 92.8 wt %.
(e2) Ecopiren 3.5NP was a natural Mg hydroxide obtained by brucite grinding followed by surface treatment with alkyl silanes, which was distributed by Europiren B.V and produced by Russian Mining Chemical Company LLC. Ecopiren 3.5NP had a D50 particle size of 3-4 pm, a surface area of 9-11 m²/g, and a minimum Mg(OH)₂ content of 92.8 wt %.
(e3) Apyral aluminum trihydrate had a D50 particle size of 1-2 μm and a surface area of 3-6 m²/g, which was commercially available from Nabaltec.

Antioxidants: Silmastab AE1527 was commercially available from Silma Srl.

Processing aid: Silmaprocess AL1142 was commercially available from Silma Srl.

### Example 1-4 and Comparative 1-2

The samples were prepared on a roll mill with a gap of 1.2-1.3 mm between the rolls. The samples were homogenized at a temperature in the range 130-140° C. and a mixing time of around 10 min.

The amount and type of components are provided in Table 1. Tests results are provided in Table 2.

TABLE 1
Composition

| Example | | 1 | 2c | C1 | 3 | 4 | C2c |
|---|---|---|---|---|---|---|---|
| Component (a1) | phr | 50 | 50 | | 40 | | |
| Component (a2) | phr | | | | | 40 | |
| Component (a3) | phr | | | 40 | | | 40 |
| Component (b) | phr | 38 | 38 | 38 | 40 | 40 | 40 |
| Component (c) | phr | 12 | 12 | 12 | 10 | 10 | 10 |
| Component (d) | phr | — | — | 10 | 10 | 10 | 10 |
| Component (e1) | phr | 150 | | | 150 | 150 | 150 |
| Component (e2) | Phr | | 150 | | | | |
| Component (e3) | phr | | | 150 | | | |
| Antioxidant | phr | 1.5 | 1.5 | 1.5 | 1.5 | 1.5 | 1.5 |
| Processing aid | phr | 4 | 4 | 4 | 4 | 4 | 4 |

TABLE 2
Properties

| Example | | 1 | 2c | C1 | 3 | 4 | C2c |
|---|---|---|---|---|---|---|---|
| MFR | g/10′ | | | | 6.6 | 12.6 | 1.4 |
| LOI | % O₂ | 36 | 45 | 33 | 37 | 37 | 33 |
| Peak heat Release | kW/m² | 208 | 185 | 244 | | | |
| rate | | | | | | | |
| Max. average rate | kW/m² | 129 | 116 | 135 | | | |
| of heat emission | | | | | | | |
| Max smoke | m²/m²s | 2.8 | 3.0 | 4.5 | | | |
| production rate | | | | | | | |
| Tensile strength at | MPa | | | | 10.3 | 10.1 | 11 |
| break | | | | | | | |
| El. At break | % | | | | 165 | 148 | 173 |

1. A thermoplastic composition for electrical cable coating comprising:
(i) a polyolefin portion comprising
(a) an ethylene copolymer being an ethylene/alkyl acrylate,
(b) a polyolefin elastomer (POE) being selected from copolymers of ethylene with a C₃-C₁₅ alpha-olefin, and optionally with a diene, having a density (ASTM D505) of from 0.860 to 0.904 g/cm³,
(c) a polymeric coupling agent selected from ethylene polymers grafted with carboxyl groups or organic silane groups, and optionally
(d) a copolymer of ethylene with a C₄-C₁₀ alpha-olefin, having a density of from 0.910 to 0.924 g/cm³, and
(ii) a mineral portion comprising
(e) magnesium hydroxide, said
wherein the components (a)-(e) being present in amount such that the weight ratio (e)/polyolefin portion ranges from 0.8:1 to 1.75:1, the weight ratio (a)/(b) ranges from 0.75:1 to 1.25:1, and the weight ratio (a)/(e) ranges from 0.15:1 to 0.4:1; and
wherein the thermoplastic composition having a melt flow rate (MFR) at 190° C. with a load of 21.6 kg, according to ISO 1133-2:2011, of at least 2 g/10 min.

2. The thermoplastic composition of claim 1, wherein the ethylene copolymer (a) is selected from the group consisting of ethylene/butyl acrylate (EBA), ethylene/ethyl acrylate (EEA), and ethylene/methyl acrylate (EMA).

3. The thermoplastic composition according to claim 2, wherein the ethylene copolymer (a) has the alkyl acrylate content ranging from 10 to 20 wt %, a MFR ranging from 0.5 to 25 g/10 min, and a density ranging from 0.920 to g/cm³.

4. The thermoplastic composition according to claim 1, wherein the C₃-C₁₅ alpha-olefin of the polyolefin elastomer (b) is a C₄-C₁₂ alpha-olefin in an amount ranging from 3-25% by mole.

5. The thermoplastic composition according to claim 4, wherein the polyolefin elastomer (b) has a density ranging from 0.870 and 0.90 g/cm³ and a MFR at 190° C. with a load of 2.16 kg, according to ISO 1133-2:2011, ranging from 0.1 to 30 g/10 min.

6. The thermoplastic composition according to claim 1, wherein the polymer coupling agent (c) is a maleic anhydride grafted polyethylene (MAHg-PE), having the content of grafted organo-functional group in the range of −0.05 to 10 weight percent based on the weight of the resin.

7. The thermoplastic composition according to claim 1 further comprising component the ethylene copolymer (d), having a density of from 0.912 to 0.922 g/cm³.

8. The thermoplastic composition according to claim 7, wherein the alpha-olefin of the ethylene copolymer (d) is selected from the group consisting of 1-butene, 1-hexene, and 1-octene, and present in the copolymer in an amount of from 1 to 12% by moles, and wherein the ethylene copolymer (d) having a melt flow rate (MFR) at 190° C. with a load of 2.16 kg, according to ISO 1133-2:2011, ranging from 0.5 to 20 g/10 min.

9. The thermoplastic composition according to claim 1 wherein the magnesium hydroxide (e) is selected from the group consisting of natural magnesium hydroxide and surface treated magnesium hydroxide, having a specific surface area of the ground product ranging from 5 and 20 m²/g and an average particle diameter of between 1 and 15 um.

10. The thermoplastic composition according to claim 9, wherein the surface treated magnesium hydroxide is obtained by treating natural magnesium hydroxide with organic silanes.

11. The thermoplastic composition according to claim 1 wherein the components (a) to (e) are present in amount such that the weight ratio (e)/polyolefin portion ranges from 1:1 to 1.65:1, the weight ratio (a)/(b) ranges from 0.85:1 to 1.15:1, and the weight ratio (a)/(e) ranges from 0.25:1 to 0.35:1.

12. The thermoplastic composition according to claim 11, having the following composition (phr):
Ethylene copolymer (a) from 25 to 60;
Polyolefin elastomer (b) from 25 to 60;
Polymeric coupling agent (c) from 5 to 20;
Ethylene copolymer (d) from 5 to 20; and
Magnesium hydroxide (e) from 120 to 180.

13. The composition of claim 12 further comprising 1 to 10 phr of an additive package comprising one or more of components selected from antioxidants, processing coadjuvants, lubricants, pigments, and other fillers.

14. The thermoplastic composition according to claim 1, having a melt flow rate (MFR) at 190° C. with a load of 21.6 kg, according to ISO 1133-2:2011, of at least 2.5 g/10 min.

15. An electrical cable coated with the thermoplastic composition according to claim 1.

16. The thermoplastic composition of claim 2, wherein the content of alkyl acrylate ranges from 5 to 25 wt %, based upon the total weight of the ethylene copolymer (a).
